(19) United States
(12) Patent Application Publication
(10) Pub. No.: US 2025/0264582 A1
(43) Pub. Date: Aug. 21, 2025

(54) DISTANCE MEASURING DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Masashige SATO, Nisshin-shi (JP); Chihiro MORIGUCHI, Nisshin-shi (JP)

(21) Appl. No.: 19/018,558

(22) Filed: Jan. 13, 2025

(30) Foreign Application Priority Data
Feb. 19, 2024 (JP) 2024-023097

(51) Int. Cl. G01S 7/481; G01S 7/4912; G01S 7/4914; G01S 7/493; G01S 17/34

(52) U.S. Cl. CPC G01S 7/4816; G01S 7/4817; G01S 7/4914; G01S 7/4917; G01S 7/493; G01S 17/34

(57) ABSTRACT

A distance measuring device includes a light source unit configured to emit an emitted light, an optical path splitting unit configured to split a reflected light from an object into optical paths, a lens unit including lenses configured to condense the reflected light split by the optical path splitting unit, receiving units configured to perform heterodyne detection on combined lights of the reflected light and a reference light and output beat signals, Fourier transforming units configured to perform a Fourier transform on the beat signals to obtain power spectra, and a peak extracting unit configured to extract a peak frequency having a correlation with a distance to the object from a sum of the power spectra. The optical path splitting unit splits the reflected light using a beam splitter independent of a polarization of the emitted light. The lenses have different numerical apertures.

### CROSS REFERENCE TO RELATED APPLICATION

The present application claims the benefit of priority from Japanese Patent Application No. 2024-023097 filed on Feb. 19, 2024. The entire disclosure of the above application is incorporated herein by reference.

### TECHNICAL FIELD

The present disclosure relates to a distance measuring device that measures a distance to an object by coherent detection.

### BACKGROUND

Conventionally, in distance measuring devices, a technique has been known for reducing speckle by separating a reflected wave of circularly polarized light emitted from a light source into S-polarized and P-polarized light using a polarizing beam splitter, and then adding the separated polarized light (hereinafter also referred to as polarization multiplexing).

### SUMMARY

The present disclosure provides a distance measuring device including a light source unit configured to emit an emitted light, an optical path splitting unit configured to split a reflected light from an object into a plurality of optical paths, a lens unit including a plurality of lenses configured to condense the reflected light, a plurality of receiving units configured to perform heterodyne detection on a plurality of combined lights obtained by combining the reflected light and a reference light and output a plurality of beat signals, a plurality of Fourier transforming units configured to perform a Fourier transform on the plurality of beat signals to obtain a plurality of power spectra, and a peak extracting unit configured to extract a peak frequency having a correlation with a distance to the object from a sum of the plurality of power spectra. The optical path splitting unit is configured to split the reflected light using a beam splitter independent of a polarization of the emitted light. The plurality of lenses have different numerical apertures.

### BRIEF DESCRIPTION OF DRAWINGS

Objects, features and advantages of the present disclosure will become apparent from the following detailed description made with reference to the accompanying drawings. In the drawings:

FIG. 1 is a schematic diagram showing a configuration of a distance measuring device according to a first embodiment;

FIG. 2 is a diagram for explaining an emitted light and a reflected light;

FIG. 3 is a diagram for explaining a numerical aperture of a lens;

FIG. 4A is a diagram for explaining variations in light intensity caused by speckle;

FIG. 4B is a diagram for explaining variations in light intensity caused by speckle;

FIG. 4C is a diagram for explaining variations in light intensity caused by speckle;

FIG. 4D is a diagram for explaining variations in light intensity caused by speckle;

FIG. 4E is a diagram for explaining variations in light intensity caused by speckle;

FIG. 5A is a diagram for explaining probability distributions before addition of power spectra;

FIG. 5B is a diagram for explaining a probability distribution after addition of the power spectra;

FIG. 6 is a diagram for explaining how to obtain a beat frequency;

FIG. 7 is a schematic diagram showing a configuration of a distance measuring device according to a modification of the first embodiment;

FIG. 8 is a schematic diagram showing a configuration of a distance measuring device according to a second embodiment;

FIG. 9 is a schematic diagram showing a configuration of a distance measuring device according to a third embodiment;

FIG. 10 is a schematic diagram showing a configuration of a distance measuring device according to a fourth embodiment; and

FIG. 11 is a schematic diagram showing a configuration of a distance measuring device according to a fifth embodiment.

### DETAILED DESCRIPTION

In a technique of reducing speckle by polarization multiplexing, a circularly polarized reflected wave is separated into S-polarized and P-polarized light using a polarizing beam splitter. Thus, the multiplicity is limited to “2” when using a single light source. In order to increase the multiplicity, it is necessary to increase the number of light sources.

A distance measuring device according to an aspect of the present disclosure is for measuring a distance to an object by coherent detection, and includes a light source unit, an optical path splitting unit, a lens unit, a plurality of receiving units, a plurality of Fourier transforming units, and a peak extracting unit. The light source unit is configured to emit an emitted light. The optical path splitting unit is configured to split a reflected light into a plurality of optical paths. The reflected light is generated when the emitted light from the light source unit is reflected by the object. The lens unit includes a plurality of lenses disposed corresponding to the plurality of optical paths, respectively. The plurality of lenses are configured to condense the reflected light that has been split into respective ones of the plurality of optical paths. The plurality of receiving units are disposed corresponding to the plurality of optical paths, respectively, and configured to perform heterodyne detection on respective ones of a plurality of combined lights, each of which is obtained by combining the reflected light and a reference light that is a part of the emitted light, and output a plurality of beat signals, respectively. The plurality of Fourier transforming units are disposed corresponding to the plurality of receiving units, respectively, and configured to perform a Fourier transform on respective ones of the plurality of beat signals to obtain a plurality of power spectra, respectively. The peak extracting unit configured to extract a peak frequency having a correlation with the distance to the object from a sum of the plurality of power spectra obtained by the plurality of Fourier transforming units. The optical path splitting unit is configured to split the reflected light into the plurality of optical paths using a beam splitter independent of a polarization of the emitted light. The plurality of lenses have different numerical apertures.

As described above, in a configuration in which the reflected light is split into the plurality of optical paths using the beam splitter independent of the polarization of the emitted light, the number of splits of the reflected light can be changed by, for example, increasing or decreasing the number of beam splitters, and therefore there is no restriction on the multiplicity. In addition, in the present disclosure, the plurality of combined lights of the reflected light and the reference light are condensed by the plurality of lenses having different numerical apertures, thereby reducing the correlation of the reflected light from the plurality of optical paths. Therefore, the effect of reducing speckle by adding the power spectra can be obtained.

Therefore, according to the present disclosure, it is possible to realize a distance measuring device capable of reducing speckle without being restricted by the multiplicity of a single light source.

Hereinafter, embodiments of the present disclosure will be described with reference to the drawings. In the following embodiments, parts that are the same as or equivalent to parts described in the preceding embodiment are denoted by the same reference numerals, and description thereof may be omitted. When only a part of components is described in the embodiment, components described in the preceding embodiment can be applied to other parts of the components. The following embodiments may be partially combined with each other even if such a combination is not explicitly described as long as there is no disadvantage with respect to such a combination.

### First Embodiment

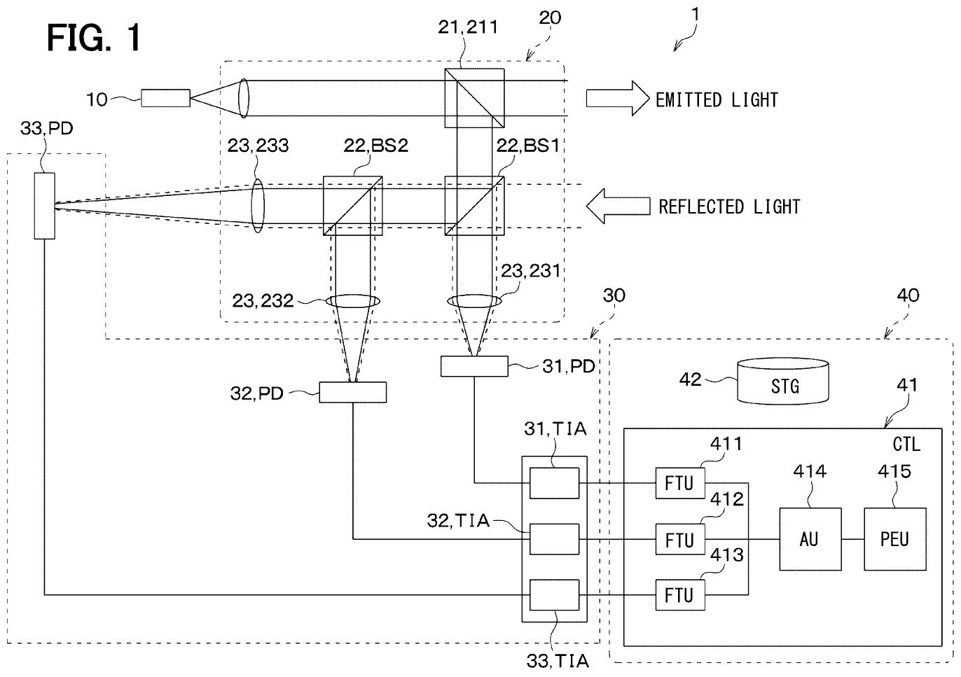

The present embodiment will be described with reference to FIGS. 1 to 6. In the present embodiment, an example will be described in which a distance measuring device 1 of the present disclosure is configured as an FMCW LiDAR mounted on a vehicle. FMCW is an abbreviation for Frequency Modulated Continuous Wave. The LiDAR is an abbreviation for Light Detection and Ranging.

The distance measuring device 1 is an optical interference measuring device that measures a distance to an object by coherent detection. As shown in FIG. 1, the distance measuring device 1 includes a light source unit 10, an optical system 20, a light receiving unit 30, and a signal processing unit 40.

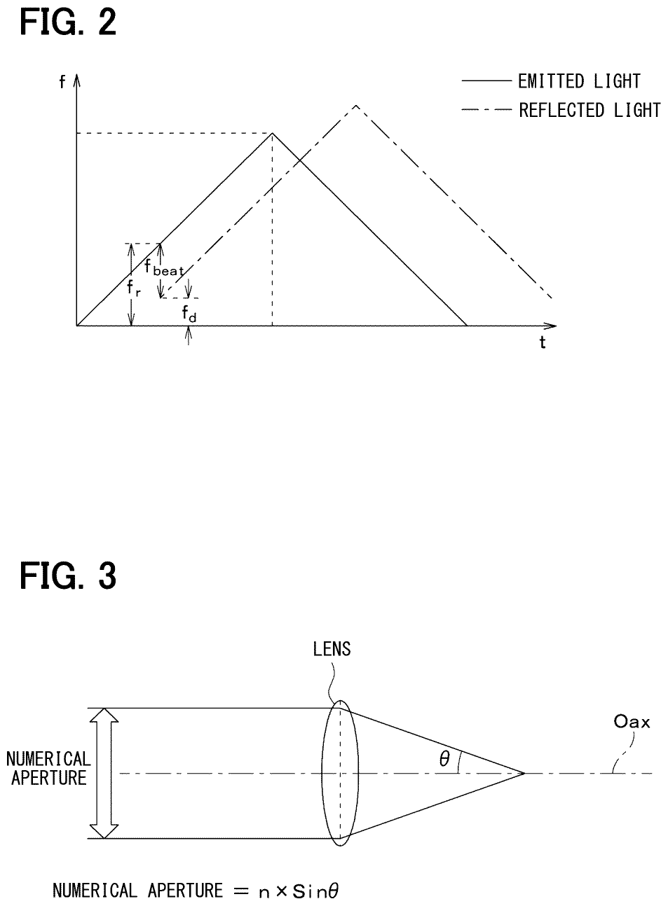

The light source unit 10 is a device that emits a laser light. Although not shown, the light source unit 10 includes a laser oscillator and a modulator. The laser oscillator generates and outputs a laser light of a predetermined frequency. The modulator performs frequency modulation with a predetermined amplitude on the laser light output from the laser oscillator, and outputs an emitted light whose frequency changes over time to the optical system 20. The emitted light from the light source unit 10 is, for example, as shown in FIG. 2, a triangular wave having an up-chirp period in which the frequency increases linearly and a down-chirp period in which the frequency decreases linearly.

The optical system 20 is a spatial interference optical system that forms an optical path to guide a part of the emitted light from the light source unit 10 to the object. The optical system 20 combines a reflected light that is generated when the emitted light is reflected by the object with a reference light that is a part of the emitted light, and outputs the combined light of the reflected light and the reference light to the light receiving unit 30. Specifically, the optical system 20 includes a light guiding unit 21, an optical path splitting unit 22, and a lens unit 23.

The light guiding unit 21 irradiates a part of the emitted light from the light source unit 10 as a measurement light toward the object. The light guiding unit 21 includes an optical splitter 211 that splits the emitted light from the light source unit 10, a circulator (not shown), and a beam scanner (not shown).

The optical splitter 211 splits the emitted light from the light source unit 10 into the measurement light and the reference light to be combined with the reflected light. The optical splitter 211 has a split ratio set so that when the measurement light is 10 to 100 mW, the reference light is several mW.

The circulator is an optical component that has three ports. The circulator outputs the emitted light, which is input to a first port via the optical splitter 211, from a second port to the beam scanner, and also outputs the reflected light, which is input from the beam scanner to the second port, from a third port to the optical path splitting unit 22.

The optical path splitting unit 22 splits the reflected light, which is generated when the emitted light from the light source unit 10 is reflected by the object, into a plurality of optical paths. The optical path splitting unit 22 of the present embodiment is configured to split into three optical paths that guide the reflected light to respective receiving units 31 to 33.

Specifically, the optical path splitting unit 22 includes a first beam splitter BS1 and a second beam splitter BS2. Each of the beam splitters BS1 and BS2 is configured as a non-polarizing beam splitter that is independent of a polarization of the emitted light.

The first beam splitter BS1 combines the reflected light and the reference light output from the circulator, and splits the combined light of the reflected light and the reference light into an optical path toward a first receiving unit 31 described later and an optical path toward the second beam splitter BS2. The splitting ratio of the first beam splitter BS1 is set so that the intensity of the light directed toward the first receiving unit 31 and the intensity of the light directed toward the second beam splitter BS2 are equal to each other, for example.

The second beam splitter BS2 splits the combined light of the reflected light and the reference light output from the first beam splitter BS1 into an optical path toward the second receiving unit 32 described later and an optical path toward the third receiving unit 33 described later. The splitting ratio of the second beam splitter BS2 is set so that the intensity of the light directed toward the second receiving unit 32 and the intensity of the light directed toward the third receiving unit 33 are equal to each other, for example.

The optical path splitting unit 22 in the present embodiment is configured to cause the first beam splitter BS1 to function as a multiplexer and a splitter. However, the present disclosure is not limited to this example and may be configured to have a multiplexer and a splitter separately.

The lens unit 23 condenses combined lights obtained by combining the reflected light split into the plurality of optical paths and the reference light which is a part of the emitted light. The lens unit 23 includes lenses 231 to 233 in the same number as the number of optical paths split by the optical path splitting unit 22.

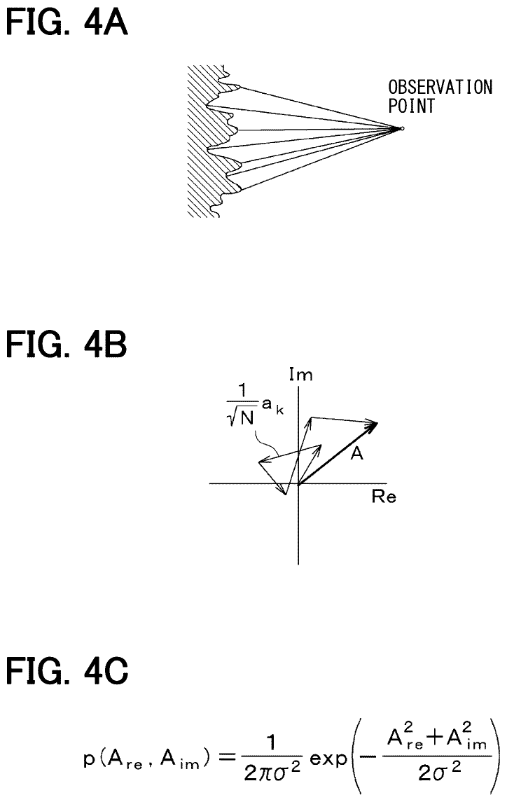

Specifically, the lens unit 23 includes a first lens 231, a second lens 232, and a third lens 233. The lenses 231 to 233 have different numerical apertures. As shown in FIG. 3, the numerical aperture is defined as the sine value of the maximum angle θ formed with the optical axis Oax (that is, sinθ) multiplied by the refractive index n. The first lens 231, the second lens 232, and the third lens 233 may have the same aperture diameter or different aperture diameters as long as they have different numerical apertures.

The light receiving unit 30 receives the combined lights of the reflected wave and the reference light condensed by the lens unit 23, and performs heterodyne detection on the combined lights to output beat signals. The light receiving unit 30 includes the receiving units 31 to 33 in the same number as the number of optical paths split by the optical path splitting unit 22.

Specifically, the light receiving unit 30 includes the first receiving unit 31, the second receiving unit 32, and the third receiving unit 33. The first receiving unit 31, the second receiving unit 32, and the third receiving unit 33 each include a photodetector PD and a transimpedance amplifier TIA. The photodetector PD photoelectrically converts the combined light, and includes, for example, a photodiode. The transimpedance amplifier TIA converts a current signal output by the photodetector PD into a voltage signal, and outputs the converted voltage signal to the signal processing unit 40 as the beat signal.

The signal processing unit 40 detects the distance to the object and the like, based on the beat signals received from the light receiving unit 30. The signal processing unit 40 includes a control unit (CTL) 41 that executes various types of arithmetic processing, and a storage unit (STG) 42.

The storage unit 42 includes a non-volatile memory such as a read only memory (ROM), a volatile memory such as a random access memory (RAM), and a flash memory. The storage unit 42 stores, for example, programs and various parameters used in the arithmetic processing in the control unit 41. The storage unit 42 includes a non-transitory tangible storage medium.

The control unit 41 executes various types of arithmetic processing based on programs and the like stored in the storage unit 42. The control unit 41 serves as a functional unit for implementing various functions of the signal processing unit 40.

The control unit 41 performs a Fourier transform on the beat signals received from the light receiving unit 30 to obtain a power spectrum, and detects the distance to the object and the like based on a peak frequency related to the distance to the object in the power spectrum that is obtained.

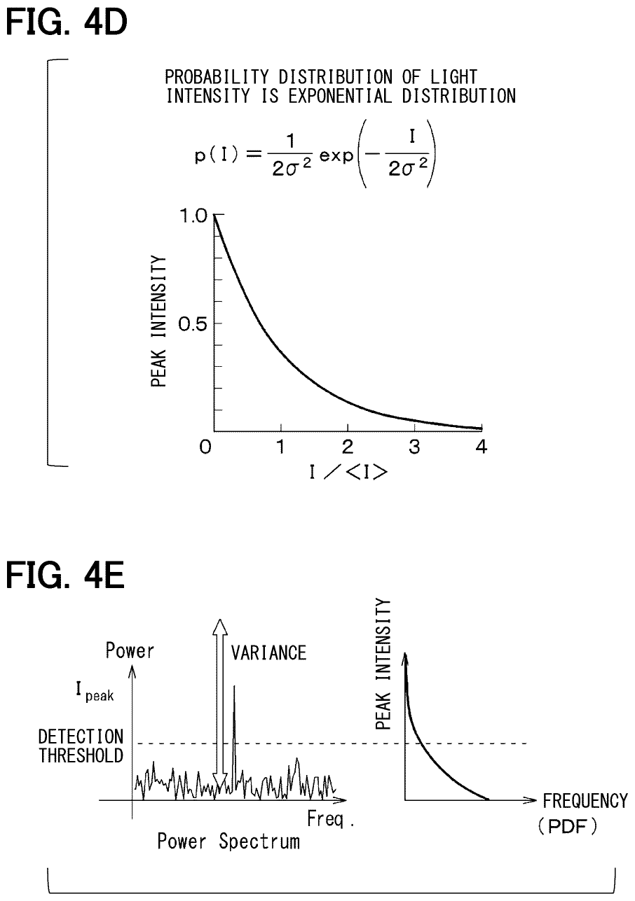

As shown in FIG. 4A, when the laser light strikes an uneven surface on an object, random optical interference occurs. This results in a random interference pattern in a reflected light observed at an observation point. This phenomenon is called speckle.

In general, the statistics of the real and imaginary parts of the complex amplitude of such reflected light can be treated as following a two-dimensional normal distribution, as shown in FIG. 4B and FIG. 4C. Moreover, as shown in FIG. 4D, the probability distribution of the light intensity of the reflected light is an exponential distribution. The intensity of the peak frequency in the power spectrum based on the beat signal (hereinafter also referred to as peak intensity Iₚₑₐₖ) varies exponentially due to the influence of speckle, as shown in FIG. 4E. As described above, the technique of reducing speckle by polarization multiplexing is known. However, in the technique, the circularly polarized reflected wave is separated into S-polarized and P-polarized light using the polarizing beam splitter. Thus, the multiplicity is limited to “2” when using a single light source. Thus, it is necessary to increase the number of light sources in order to increase the multiplicity.

Taking these factors into consideration, the control unit 41 performs the Fourier transform on the beat signals received by the receiving units 31 to 33 to obtain power spectra, and detects the distance to the object and the like, based on a signal obtained by adding up the obtained power spectra.

Specifically, the control unit 41 of the present embodiment includes a plurality of Fourier transforming units (FTU) 411 to 413, an adding unit (AU) 414, and a peak extracting unit (PEU) 415 as functional units for detecting the distance to the object and the like.

Each of the Fourier transforming units 411 to 413 performs a Fourier transform on the beat signal to obtain a power spectrum. The first Fourier transforming unit 411 performs the Fourier transform on the beat signal received from the first receiving unit 31 to obtain a power spectrum. The second Fourier transforming unit 412 performs the Fourier transform on the beat signal received from the second receiving unit 32 to obtain a power spectrum. The third Fourier transforming unit 413 performs rge Fourier transform on the beat signal received from the third receiving unit 33 to obtain a power spectrum.

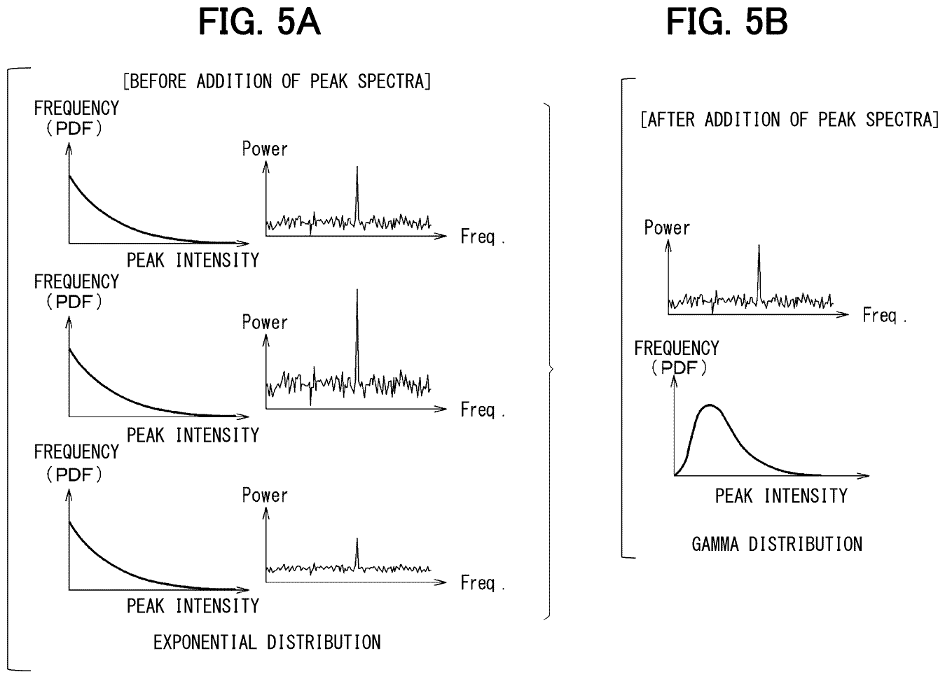

As shown in FIG. 5A, the adding unit 414 adds up the power spectra obtained by the Fourier transforming units 411 to 413. In the distance measuring device 1 of the present disclosure, the combined lights of the reflected light and the reference light are condensed by the lenses 231 to 233 having different numerical apertures. Therefore, the correlation of the reflected light from the plurality of optical paths becomes small. Therefore, in the power spectrum after the addition, as shown in FIG. 5B, a probability distribution of a peak intensity Iₚₑₐₖ related to the distance to the object in the power spectrum becomes a gamma distribution, and the variation in the peak intensity Iₚₑₐₖ is restricted. As a result, an effect of reducing speckle can be obtained. The addition in the adding unit 414 may be a simple sum or an arithmetic average.

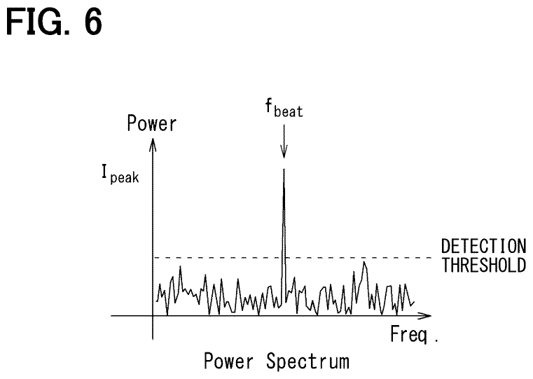

The peak extracting unit 415 extracts a peak frequency that has a correlation with the distance to the object from the sum of the power spectra obtained by the Fourier transforming units 411 to 413. The peak extracting unit 415 extracts, for example, as shown in FIG. 6, a peak frequency having a peak intensity Iₚₑₐₖ exceeding a predetermined detection threshold in the power spectrum after addition, as a beat frequency f_{beat} that is correlated with the distance to the object. Then, the peak extracting unit 415 calculates the distance to the object and the like based on the beat frequency f_{beat}. As shown in FIG. 2, the beat frequency f_{beat} is the difference between the frequency fr of the reference light, which is a part of the emitted light, and the frequency fd of the reflected light. The beat frequency f_{beat} is determined by a phase difference that occurs between the reference light and the reflected light depending on the distance to the object, and a Doppler shift that occurs between the reference light and the reflected light depending on the relative speed of the object. Therefore, by specifying the beat frequency f_{beat}, a position, a velocity, and the like of the object can be obtained.

Next, the operation of the distance measuring device 1 will be described. When a start switch of the vehicle is turned on, the operation of the distance measuring device 1 starts. Then, a light is emitted from the light source unit 10, and a part of the emitted light is emitted to an object as a target via the circulator and the beam scanner in the light guiding unit 21 of the optical system 20. Further, another part of the emitted light from the light source unit 10 is split as the reference light by the optical splitter 211 of the optical system 20 and is guided to the first beam splitter BS1 of the optical path splitting unit 22.

The reflected light generated when the emitted light is reflected by the object passes through the beam scanner and the circulator, and is then combined with the reference light by the first beam splitter BS1.

The combined light of the reflected light and the reference light is first split by the first beam splitter BS1 into a light directed toward the first receiving unit 31 and a light directed toward the second beam splitter BS2. The light directed toward the second beam splitter BS2 is split by the second beam splitter BS2 into a light directed toward the second receiving unit 32 and a light directed toward the third receiving unit 33.

The light directed toward the first receiving unit 31 is condensed by the first lens 231 and output to the first receiving unit 31. The light directed toward the second receiving unit 32 is condensed by the second lens 232 and output to the second receiving unit 32. The light directed toward the third receiving unit 33 is condensed by the third lens 233 and output to the third receiving unit 33.

The receiving units 31 to 33 receive the combined lights of the reflected wave and the reference light condensed by the respective lenses 231 to 233, perform heterodyne detection on the combined lights, and output the beat signals to the signal processing unit 40.

The signal processing unit 40 performs the Fourier transform on the beat signals received from the receiving units 31 to 33 to obtain power spectra, and adds up the obtained power spectra. The signal processing unit 40 then detects the distance to the object and the like, based on the peak frequency related to the distance to the object in the power spectrum after the addition.

The distance measuring device 1 described above is configured so that the optical path splitting unit 22 uses the beam splitters BS independent of the polarization of the emitted light to split the reflected light into multiple optical paths, and the lenses 231 to 233 are set to have different numerical apertures.

In this manner, in a configuration in which the reflected light is split into the plurality of optical paths using the beam splitters BS independent of the polarization of the emitted light, the number of beam splitters BS can be increased or decreased to change the number of splits of the reflected light, and therefore there is no restriction on multiplicity.

In addition, in the distance measuring device 1 of the present disclosure, the combined lights of the reflected light and the reference light are condensed by the plurality of lenses 231 to 233 having different numerical apertures, thereby reducing the correlation of the reflected light from the plurality of optical paths. Therefore, the effect of reducing speckle by adding the power spectra can be obtained.

Therefore, according to the distance measuring device 1 of the present disclosure, speckle can be reduced without being restricted by the multiplicity of a single light source.

The distance measuring device 1 of the present embodiment also has the following features.

The optical path splitting unit 22 of the present embodiment is configured to split the reflected light into three optical paths. In this way, when the optical path splitting unit 22 is configured to split the reflected light into three optical paths, the degree of multiplexing can be increased compared to the technique of reducing speckle by polarization multiplexing, and therefore the effect of reducing speckle can be improved without increasing the number of light source unit 10.

In the receiving units 31 to 33 of the present embodiment, the combined lights condensed by the lenses 231 to 233 are directly irradiated onto the photodetectors PD for photoelectric conversion. This allows the receiving units 31 to 33 to appropriately receive the combined lights having low correlation.

### (Modifications of First Embodiment)

In the first embodiment, an example has been described in which the optical path splitting unit 22 is configured to split the reflected light into three optical paths. However, the optical path splitting unit 22 may be configured to split the reflected light into two optical paths, or may be configured to split the reflected light into four or more optical paths.

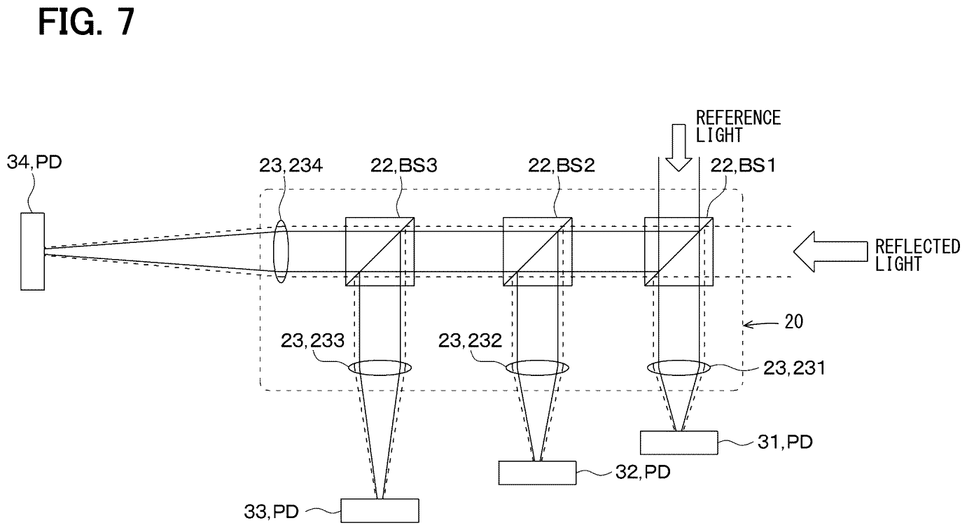

For example, as shown in FIG. 7, the distance measuring device 1 may be configured such that the optical path splitting unit 22 splits the reflected light into four optical paths. Such a configuration can be realized by adding a third beam splitter BS3, forming a lens unit 23 including lenses 231-234 in the same number as the optical paths split by the optical path splitting unit 22, and forming a light receiving unit 30 including receiving units 31-34 in the same number as the optical paths split by the optical path splitting unit 22.

### Second Embodiment

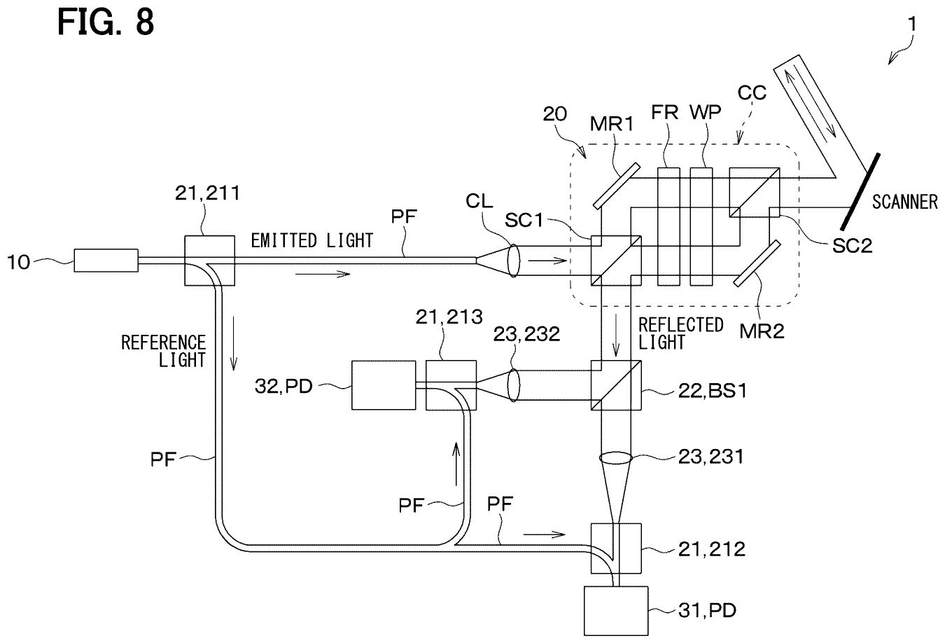

Next, a second embodiment will be described with reference to FIG. 8. In the present embodiment, differences from the first embodiment will be mainly described.

As shown in FIG. 8, the distance measuring device 1 of the present embodiment is configured such that the optical path splitting unit 22 splits the reflected light into two optical paths. Specifically, the optical path splitting unit 22 includes a first beam splitter BS1. The lens unit 23 includes a first lens 231 and a second lens 232 that are disposed on the respective optical paths split by the optical path splitting unit 22. The light receiving unit 30 includes a first receiving unit 31 and a second receiving unit 32 that are connected to ends of the optical paths split by the optical path splitting unit 22. Although not shown, the functional units of the signal processing unit 40 are provided in a number corresponding to the number of optical paths split by the optical path splitting unit 22.

A splitting ratio of the first beam splitter BS1 is set so that the reflected lights to be condensed by the first lens 231 and the second lens 232 have the same intensity. In the present embodiment, the splitting ratio of the first beam splitter BS1 is set so that the intensities of the reflected lights to be condensed by the first lens 231 and the second lens 232 are 1:1.

In addition, in the distance measuring device 1, a part of the optical system 20 is composed of an optical fiber PF. Specifically, in the optical system 20, the optical path from the light source unit 10 to a first port of a circulator CC is formed by the optical fiber PF. An end of the optical fiber PF is connected to the first port of the circulator CC via a collimator CL.

The circulator CC is configured as a non-polarizing circulator that is independent of polarization. The circulator CC is configured as a modular unit including a Faraday rotator FR, a half-wave plate WP, spectrometers SC1 and SC2, and reflecting mirrors MR1 and MR2.

In addition, in the optical system 20 of the present embodiment, the optical paths from the lens 231, 232 to the respective receiving units 31, 32, and the optical path connected to these optical paths for guiding the reference light from the optical splitter 211 to the respective receiving units 31, 32 are composed of optical fibers PF. As a result, the reflected light that has been condensed by each of the lenses 231, 232 is guided to the photodetector PD of each of the receiving units 31, 32 via the optical fiber PF and is photoelectrically converted. In the present embodiment, the reflected light and the reference light condensed by the lenses 231 and 232 are combined by optical multiplexers 212 and 213 disposed between the photodetectors PD and the lenses 231 to 233.

The other configurations are the same as those in the first embodiment. The distance measuring device 1 in the present embodiment can achieve the effects obtained from the common configuration or the equivalent configuration to the first embodiment.

The distance measuring device 1 of the present embodiment also has the following features.

In the optical path splitting unit 22 of the present embodiment, the splitting ratio of the first beam splitter BS1 is set so that the intensities of the reflected lights to be condensed by the lenses 231 and 232 are equal to each other. If there is variation in the intensities of the reflected lights to be condensed by the lenses 231 and 232, there is a possibility that the effect of reducing speckle due to the addition of power spectra will be restricted. Therefore, in the optical path splitting unit 22, it is desirable that the splitting ratio of the first beam splitter BS1 is set so that the intensities of the reflected lights to be condensed by the lenses 231 and 232 are equal to each other.

In the receiving units 31 and 32 of the present embodiment, the reflected lights that have been condensed by the lenses 231 and 232 are guided to the photodetectors PD for photoelectric conversion via the respective optical fibers PF. This makes it easier to arrange the optical paths from the lenses 231 and 232 to the photodetectors PD. This contributes greatly to making the distance measuring device 1 more compact.

### Third Embodiment

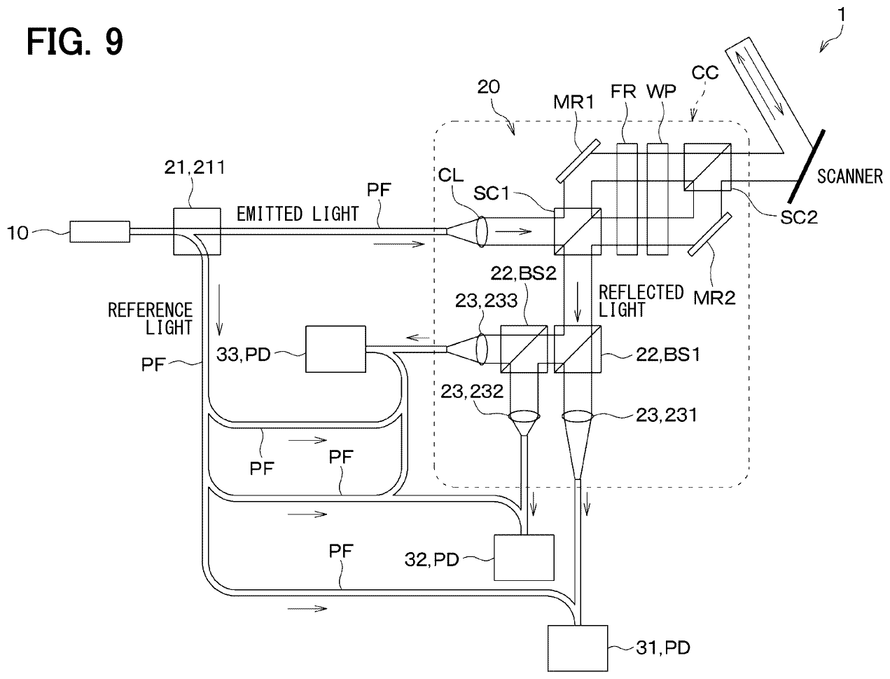

Next, a third embodiment will be described with reference to FIG. 9. In the present embodiment, differences from the second embodiment will be mainly described.

As shown in FIG. 9, the distance measuring device 1 of the present embodiment is configured such that the optical path splitting unit 22 splits the reflected light into three optical paths. Specifically, the optical path splitting unit 22 includes a first beam splitter BS1 and a second beam splitter BS2. The lens unit 23 includes a first lens 231, a second lens 232, and a third lens 233 that are arranged on the optical paths split by the optical path splitting unit 22. The light receiving unit 30 includes a first receiving unit 31, a second receiving unit 32, and a third receiving unit 33 that are connected to ends of the optical paths split by the optical path splitting unit 22. Although not shown, the functional units of the signal processing unit 40 are provided in a number corresponding to the number of optical paths split by the optical path splitting unit 22.

Here, the splitting ratios of the first beam splitter BS1 and the second beam splitter BS2 are set so that intensities of the reflected lights to be condensed by the lenses 231 to 233 are equal to each other. In the present embodiment, the splitting ratio of the first beam splitter BS1 is set so that the intensity of the light to be condensed by the first lens 231 and the intensity of the light directed toward the second beam splitter BS2 become 1:2. The splitting ratio of the second beam splitter BS2 is set so that the intensity of the light to be condensed by the second lens 232 and the third lens 233 becomes 1:1.

In addition, in the distance measuring device 1, some parts of the optical system 20 are composed of optical fibers PF. Specifically, in the optical system 20, an optical path from the light source unit 10 to the first port of the circulator CC is formed by an optical fiber PF. In the optical system 20, optical paths from the lenses 231 to 233 to the receiving units 31 to 33, and an optical path connected to the optical paths for guiding the reference light from the optical splitter 211 to the receiving units 31 to 33 are composed of optical fibers PF. As a result, the reflected light that has been condensed by each of the lenses 231 to 233 is guided to the photodetectors PD of each of the receiving units 31 to 33 via the optical fiber PF and is photoelectrically converted. In the present embodiment, the reflected light condensed by each of the lenses 231 to 233 and the reference light are combined in the optical path between the photodetector PD and each of the lenses 231 to 233.

Furthermore, in the distance measuring device 1 of the present embodiment, the collimator CL, the circulator CC, the optical path splitting unit 22, and the lens unit 23 are modularized as a single optical path module. Such modularization is realized, for example, by mounting the collimator CL, the circulator CC, the optical path splitting unit 22, and the lens unit 23 on a single substrate.

Others are the same as those in the second embodiment. The distance measuring device 1 in the present embodiment can achieve the effects obtained from the common configuration or the equivalent configuration to the second embodiment.

The distance measuring device 1 of the present embodiment also has the following features.

In the distance measuring device 1 of the present embodiment, the collimator CL, the circulator CC, the optical path splitting unit 22, and the lens unit 23 are modularized as the optical path module. This makes it easier to configure the distance measuring device 1 compact and allows for reduction in manufacturing costs and the like.

### Fourth Embodiment

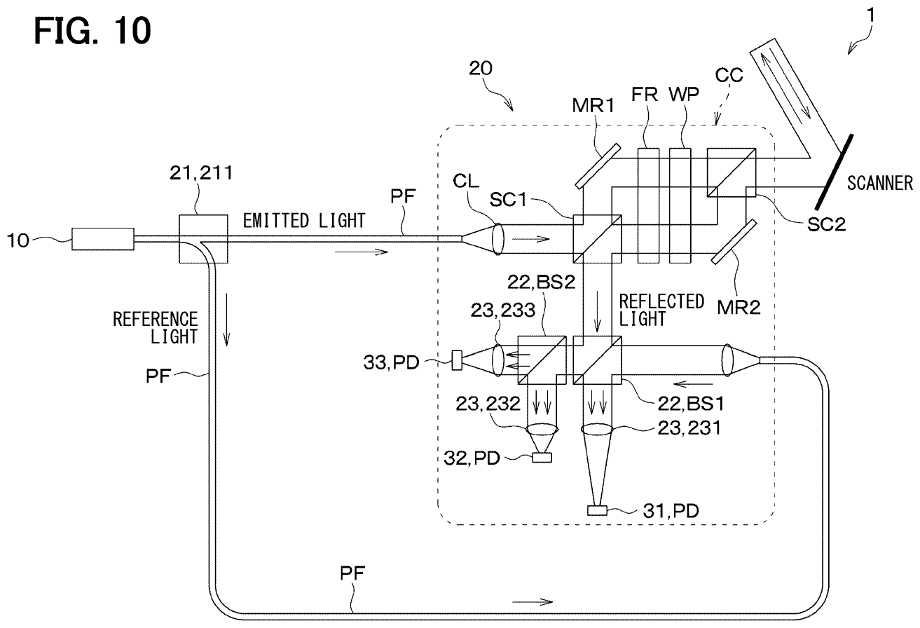

Next, a fourth embodiment will be described with reference to FIG. 10. In the present embodiment, differences from the third embodiment will be mainly described.

As shown in FIG. 10, in the optical system 20 of the present embodiment, the optical path from the light source unit 10 to the first port of the circulator CC is composed of an optical fiber PF. In the optical system 20, an optical path from the optical splitter 211 to the first beam splitter BS1 is connected by an optical fiber PF so that the reference light is guided to the first beam splitter BS1. As a result, the reference light is guided to the first beam splitter BS1 via the optical fiber PF, and is combined with the reflected light by the first beam splitter BS1.

Moreover, the combined light of the reflected light and the reference light is split by the first beam splitter BS1 into a light directed toward the first receiving unit 31 and a light directed toward the second beam splitter BS2. The light directed toward the second beam splitter BS2 is split by the second beam splitter BS2 into a light directed toward the second receiving unit 32 and a light directed toward the third receiving unit 33. As a result, in the optical system 20, the reflected light that has been condensed by each of the lenses 231 to 233 is directly guided to the photodetector PD of each of the receiving units 31 to 33 and is photoelectrically converted.

Furthermore, in the distance measuring device 1 of the present embodiment, the collimator CL, the circulator CC, the optical path splitting unit 22, the lens unit 23, and the receiving units 31 to 33 of the light receiving unit 30 are modularized as a single module. Such modularization is realized, for example, by mounting the collimator CL, the circulator CC, the optical path splitting unit 22, the lens unit 23, and the receiving units 31 to 33 on a single substrate.

The other configurations are the same as those in the third embodiment. The distance measuring device 1 in the present embodiment can achieve the effects obtained from the common configuration or the equivalent configuration to the third embodiment.

The distance measuring device 1 of the present embodiment also has the following features.

In the distance measuring device 1 of the present embodiment, the collimator CL, the circulator CC, the optical path splitting unit 22, the lens unit 23, and the receiving units 31 to 33 of the light receiving unit 30 are modularized as the single module. This makes it easier to configure the distance measuring device 1 compact and allows for reduction in manufacturing costs and the like.

### Fifth Embodiment

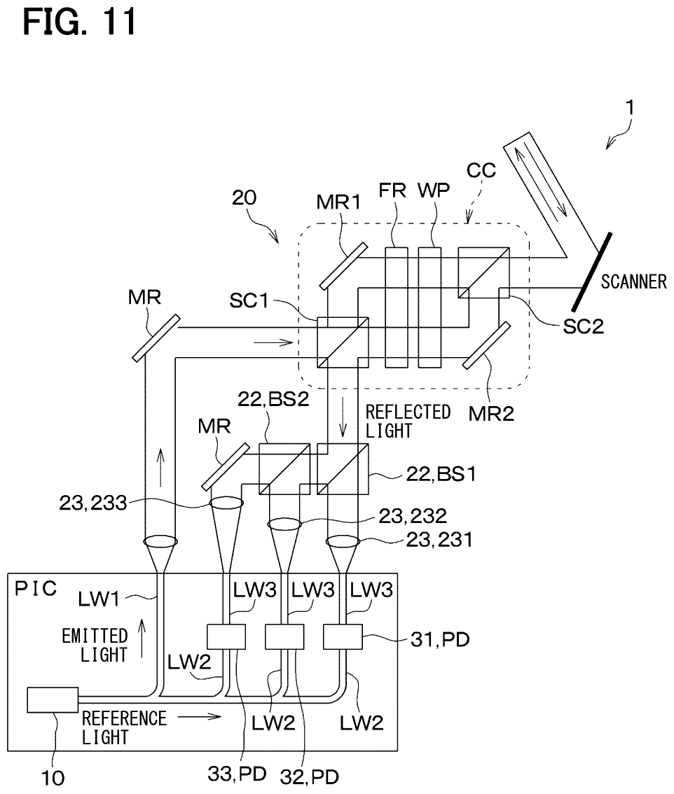

Next, a fifth embodiment will be described with reference to FIG. 11. In the present embodiment, differences from the first embodiment will be mainly described.

As shown in FIG. 11, in the distance measuring device 1 of the present embodiment, the light source unit 10 and the light receiving unit 30 are composed of an optical integrated circuit PIC. The optical integrated circuit PIC is made of a semiconductor having an optical waveguide LW. The optical integrated circuit PIC includes a first optical waveguide LW1 that guides the emitted light to the circulator CC, a second optical waveguide LW2 that guides the reference light to each of the receiving units 31 to 33, and a third optical waveguide LW3 that guides the reflected light that has been condensed by each of the lenses 231 to 233 to each of the receiving units 31 to 33. As a result, in the present embodiment, the reflected light that has been condensed by each of the lenses 231 to 233 is guided to the photodetector PD of each of the receiving units 31 to 33 via the third optical waveguide LW3 formed inside the optical integrated circuit PIC, and is photoelectrically converted. In the present embodiment, the reflected light condensed by each of the lenses 231 to 233 and the reference light are combined by the photodetector PD.

Furthermore, the optical system 20 of the present embodiment further includes a mirror MR that directs a light emitted from the first optical waveguide LW1 toward the circulator CC. In addition, a mirror MR for directing the reflected light transmitted through the second beam splitter BS2 to the third lens 233 is added to the optical path splitting unit 22.

The other configurations are the same as those in the first embodiment. The distance measuring device 1 in the present embodiment can achieve the effects obtained from the common configuration or the equivalent configuration to the first embodiment.

The distance measuring device 1 of the present embodiment also has the following features.

In each of the receiving units 31 to 33, the reflected light that has been condensed by each of the lenses 231 to 233 is guided to the photodetector PD via the third optical waveguide LW3 provided inside the optical integrated circuit PIC that is a semiconductor device, and is photoelectrically converted. In this way, if the reflected light is guided to the photodetector PD via the optical waveguide LW inside the semiconductor device, further miniaturization can be achieved.

### Other Embodiments

Although the representative embodiments of the present disclosure have been described above, the present disclosure is not limited to the embodiments described above, and can be variously modified as follows, for example.

In the above-described embodiments, various configurations of the distance measuring device 1 have been described in detail. However, configurations of the distance measuring device 1 do not need to be identical to those described above, and some of them may be different from those described above.

In the above-described embodiments, an example has been described in which the Fourier transforming units 411 to 413, the adding unit 414, and the peak extracting unit 415 are configured as the functional units of the control unit 41 in the signal processing unit 40. Each of the Fourier transforming units 411 to 413, the adding unit 414, and the peak extracting unit 415 may be configured as separate components.

In the above-described embodiments, an example has been described in which the distance measuring device 1 of the present disclosure is configured as the FMCW LiDAR mounted on the vehicle. However, the distance measuring device 1 can be applied to devices other than the FMCW LiDAR mounted on the vehicle.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, when a numerical value such as the number, a numerical value, an amount, or a range of the constituent elements of the embodiment is referred to, the numerical value is not limited to specific numerical values unless otherwise specified as being essential or obviously limited to the specific numerical values in principle.

In each of the embodiments, when the shapes, positional relationships, and the like of the constituent elements and the like are referred to, the shapes, positional relationships, and the like are not limited thereto unless otherwise specified or limited to specific shapes, positional relationships, and the like in principle.

The control unit and the method thereof of the present disclosure may be implemented by a dedicated computer provided by configuring a memory and a processor programmed to execute one or a plurality of functions embodied by a computer program. The control unit and the method therefor of the present disclosure may be realized by a dedicated computer provided by including a processor with one or more dedicated hardware logic circuits. The control unit and the method therefor of the present disclosure may be realized by one or more dedicated computers, each including a combination of a processor and a memory that are programmed to execute one or more functions and a processor formed of one or more hardware logic circuits. The computer programs may be stored, as instructions to be executed by a computer, in a tangible non-transitory computer-readable medium.

What is claimed is:

1. A distance measuring device for measuring a distance to an object by coherent detection, comprising:
a light source unit configured to emit an emitted light;
an optical path splitting unit configured to split a reflected light into a plurality of optical paths, the reflected light being generated when the emitted light from the light source unit is reflected by the object;
a lens unit including a plurality of lenses disposed corresponding to the plurality of optical paths, respectively, the plurality of lenses configured to condense the reflected light that has been split into respective ones of the plurality of optical paths;
a plurality of receiving units disposed corresponding to the plurality of optical paths, respectively, and configured to perform heterodyne detection on respective ones of a plurality of combined lights, each of which is obtained by combining the reflected light and a reference light that is a part of the emitted light, and output a plurality of beat signals, respectively;
a plurality of Fourier transforming units disposed corresponding to the plurality of receiving units, respectively, and configured to perform a Fourier transform on respective ones of the plurality of beat signals to obtain a plurality of power spectra, respectively; and
a peak extracting unit configured to extract a peak frequency having a correlation with the distance to the object from a sum of the plurality of power spectra obtained by the plurality of Fourier transforming units, wherein
the optical path splitting unit is configured to split the reflected light into the plurality of optical paths using a beam splitter independent of a polarization of the emitted light, and
the plurality of lenses have different numerical apertures.

2. The distance measuring device according to claim 1, wherein
the optical path splitting unit is configured to split the reflected light into three or more optical paths.

3. The distance measuring device according to claim 2, wherein
in the optical path splitting unit, a splitting ratio of the beam splitter is set so that an intensity of the reflected light to be condensed by each of the plurality of lenses is equal.

4. The distance measuring device according to claim 1, wherein
each of plurality of the receiving units includes a photodetector, and
the reflected light that has been condensed by each of the plurality of lenses is guided to the photodetector via an optical fiber and is photoelectrically converted by the photodetector.

5. The distance measuring device according to claim 1, wherein
each the plurality of receiving units includes a photodetector, and
the reflected light that has been condensed by each of the plurality of lenses is guided to the photodetector via a waveguide provided in a semiconductor and is photoelectrically converted by the photodetector.

6. The distance measuring device according to claim 1, wherein
each of the plurality of receiving units includes a photodetector, and
the reflected light that has been condensed by each of the plurality of lenses is directly irradiated onto the photodetector and is photoelectrically converted by the photodetector.
